(19) United States
(12) Patent Application Publication
(10) Pub. No.: US 2009/0081523 A1
(43) Pub. Date: Mar. 26, 2009

(54) FUEL CELL COVER

(75) Inventors: Anna Stukas, Vancouver (CA); Gerard F. McLean, West Vancouver (CA)

Correspondence Address: SCHWEGMAN, LUNDBERG & WOESSNER, P.A., P.O. BOX 2938, MINNEAPOLIS, MN, 55402, US

(73) Assignee: Angstrom Power, Inc..

(21) Appl. No.: 12/238,040

(22) Filed: Sep. 25, 2008

Related U.S. Application Data
(60) Provisional application No. 60/975,130, filed on Sep. 25, 2007.

(51) Int. Cl. H01M 2/04

(52) U.S. Cl. 429/34; 429/12

(57) ABSTRACT

Fuel cell covers, electronic systems and methods for optimizing the performance of a fuel cell system are disclosed. In the various embodiments, a fuel cell cover includes an interface structure proximate to one or more fuel cells. The interface structure is configured to affect one or more environmental conditions proximate to the one or more fuel cells. An electronic system includes an electronic device, one or more fuel cells operably coupled to the electronic device, and an interface structure proximate to the one or more fuel cells. The interface structure affects one or more environmental conditions near or in contact with the one or more fuel cells. A method includes providing a fuel cell layer, and positioning an interface layer proximate to the fuel cell layer.

### PRIORITY OF INVENTION

This non-provisional application claims the benefit of priority under 35 U.S.C. §119(e) to U.S. Provisional Patent Applications Serial No. 60/975,130, filed Sep. 25, 2007, which is herein incorporated by reference.

### BACKGROUND

Electrochemical cells, such as fuel cells, may utilize oxygen from the environment as a reactant. While generating electricity, the electrochemical reaction that occurs in the cell also produces water that may be directed to other electrochemical cell uses, such as membrane hydration or to the humidification of various parts of the system. The increased functionality of fuel cells for powering electronic devices now introduces the fuel cells to various environmental conditions that may affect gas transport properties of the reactants and the water management system.

Fuel cells may require that the gas diffusion layer or the interface between at least part of the cathode and the environment be electrically conductive for proper cell functionality. Because the interface may be electrically conductive, the suitability of the interface for varying environmental conditions may be limited.

### BRIEF DESCRIPTION OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, various embodiments discussed in the present document.

FIG. 1 illustrates a perspective view of a fuel cell cover with features, according to the various embodiments.

FIG. 2 illustrates a perspective view of a fuel cell cover including a removable access plate, according to the various embodiments.

FIG. 3 illustrates a perspective view of an electronic device including a fuel cell cover, according to the various embodiments.

FIG. 4 illustrates a perspective view of an electronic device including a cover substantially flush with the device, according to the various embodiments.

FIG. 5 illustrates a perspective view of an electronic device with a fuel cell cover including a removable access plate, according to the various embodiments.

FIG. 6 illustrates an exploded view of an electronic device system, according to the various embodiments.

### SUMMARY

The various embodiments relate to a fuel cell cover comprising an interface structure proximate to one or more fuel cells. The interface structure may affect one or more environmental conditions near or in contact with the one or more fuel cells.

The various embodiments relate to a fuel cell cover comprising an interface structure proximate to one or more fuel cells, wherein the cover may include one or more features to enhance the performance of the one or more fuel cells in a selected set of one or more environmental conditions.

The various embodiments also relate to a fuel cell cover comprising a cover in contact with one or more fuel cells. The cover may include one or more features that respond to a change in to one or more environmental conditions near or in contact with the one or more fuel cells in order to enhance the performance of the fuel cells.

The various embodiments may also relate to an electronic system comprising an electronic device, one or more fuel cells in contact with the electronic device and an adaptive interface structure. The cover may affect one or more environmental conditions near or in contact with the one or more fuel cells.

The various embodiments may relate to a method of making an electronic system comprising forming an electronic device, forming one or more fuel cells in contact with the electronic device, forming an interface structure, contacting the one or more fuel cells with the electronic device and contacting the cover with one or more of the fuel cells or electronic device.

### DETAILED DESCRIPTION

The following detailed description includes references to the accompanying drawings, which form a part of the detailed description. The drawings show, by way of illustration, various embodiments that may be practiced. These embodiments, which are also referred to herein as “examples,” are described in enough detail to enable those skilled in the art to practice the embodiments. The embodiments may be combined, other embodiments may be utilized, or structural, and logical changes may be made without departing from the scope of the various embodiments. The following detailed description is, therefore, not to be taken in a limiting sense, and the scope of the various embodiments is defined by the appended claims and their equivalents.

In this document, the terms “a” or “an” are used to include one or more than one and the term “or” is used to refer to a nonexclusive “or” unless otherwise indicated. In addition, it is understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The various embodiments relate to a fuel cell cover. Performance of fuel cell systems, including passive fuel cell systems, may be affected by environmental conditions, such as humidity, ambient temperature, ambient pressure, or other environmental conditions. In order to get suitable performance out of an active area of a fuel cell, as well as substantially all of the fuel cells in a stack, or in a fuel cell layer, the reactants may be approximately evenly distributed across each active area and each cell uniformly. Fuel cells may utilize some form of gas diffusion layer (GDL) that is configured to achieve this. Larger fuel cells may employ a “bipolar plate” or a “separator” plate that defines flow fields to aid in this purpose. Due to the design of most fuel cell systems, the GDL and the bipolar plate (if employed) may be electrically conductive in order to collect the electrons generated in the fuel cell reaction. Consequently, this may limit the materials that may be used to fabricate a GDL in such a fuel cell. One suitable material is a form of carbon fiber paper, which is configured to be porous and electrically conductive.

In a fuel cell architecture where a generated current is collected on the edge of the cell, (instead of into a GDL and into an associated current-carrying structure), adaptability and interchangeability in fuel cell covers may be obtained. Examples of such fuel cells may be found in the commonly owned U.S. patent application Ser. No. 11/047,560, filed Feb. 2, 2005, entitled “ELECTROCHEMICAL CELLS HAVING CURRENT-CARRYING STRUCTURES UNDERLYING ELECTROCHEMICAL REACTION LAYERS,” the disclosure of which is herein incorporated by reference.

Because the current carrying structures in such fuel cells are located at the edges of the fuel cells, planar fuel cell layers may utilize gas diffusion layers (GDL) that may not be electrically conductive. This feature may allow the use of interchangeable or adaptive covers, in accordance with the various embodiments, that may include materials and configurations not otherwise feasible for use in connection with as GDLs. Further, the various embodiments may also be utilized in conventional fuel cells with GDLs, as a feature to enhance the fuel cell performance in varying environmental conditions.

The covers according to the various embodiments may function to enable an oxidant, such as air, to contact the cathodes of the fuel cell. The material, structure, and other physical properties of the cover may affect the performance of the fuel cells. Performance of fuel cells may be affected by both environmental conditions proximal to the fuel cell, such as temperature, humidity and reactant distribution across the fuel cell, which may be affected by selection of a cover or gas diffusion layer.

The cover, according to the various embodiments, may include an interface structure that may be interchangeable or adaptable or both interchangeable and adaptable so that, in general terms, the cover is responsive to varying environmental conditions that may affect a fuel cell or fuel cell-powered electronic device. Interchangeable covers, which may be removably coupled to one or more fuel cells, may be configured to enhance the performance of the one or more fuel cells based on a set of selected environmental conditions. Adaptable covers may include one or more adaptive materials that are responsive to environmental conditions, such that the performance of the one or more fuel cells is therefore enhanced. The cover may be utilized with one or more fuel cells that may not require the cathode-environmental interface to be electrically conductive. Such fuel cells may utilize an integrated cathode, catalyst layer and current carriers, such that the interface or cover between the cathode and environment may not be electrically conductive in addition to maintaining the proper gas transport properties. The cover may therefore be used with passive, “air breathing” fuel cells, which do not actively control distribution of one or both reactants to the fuel cell layer.

In the various embodiments, where the gas diffusion layer may not be electrically conductive, the choice of material and structure is flexible to assist in altering the environment adjacent to the fuel cell or fuel cell-powered device. In addition, the cover may be utilized with an electrically conductive layer or be conductive itself, in order to function with conventional fuel cell systems. The cover may be configured to be customizable or adaptable based on structure, material or both. For example, the interchangeable or adaptable cover may affect temperature, humidity, pollutant or contaminant level in contact with the fuel cell. In the present disclosure, affecting an environmental condition proximate to a fuel cell may refer to increasing, decreasing, enhancing, regulating, controlling, or removing an environmental condition proximate to the cell.

In the various embodiments, the fuel cell cover may comprise a porous interface structure disposed on, or proximate to the reactive surface of the fuel cell layer, or it may be integrated into a conventional gas diffusion layer (GDL) of a fuel cell. The porous layer may be configured to employ an adaptable material. The porous layer may be configured to employ a thermo-responsive polymer. The polymer may include a plurality of pores. Adaptive materials included in the cover may be responsive to conditions external to the cover, conditions on or proximate to the fuel cells. Adaptive materials and structures may also include active control mechanisms, other stimuli, or any combination thereof. Some examples of conditions may include temperature, humidity, an electrical flow, or other conditions.

### DEFINITIONS

As used herein, “electrochemical array” may refer to an orderly grouping of electrochemical cells. The array may be planar or cylindrical, for example. The electrochemical cells may include fuel cells, such as edge-collected fuel cells. The electrochemical cells may include batteries. The electrochemical cells may be galvanic cells, electrolysers, electrolytic cells or combinations thereof. Examples of fuel cells include proton exchange membrane fuel cells, direct methanol fuel cells, alkaline fuel cells, phosphoric acid fuel cells, molten carbonate fuel cells, solid oxide fuel cells, or combinations thereof. The electrochemical cells may include metal-air cells, such as zinc air fuel cells, zinc air batteries, or a combination thereof.

As used herein, the term “flexible electrochemical layer” (or variants thereof) may include an electrochemical layer that is flexible in whole or in part, that may include, for example, an electrochemical layer having one or more rigid components integrated with one or more flexible components. A “flexible fuel cell layer” may refer to a layer comprising a plurality of fuel cells integrated into the layer.

The term “flexible two-dimensional (2-D) fuel cell array” may refer to a flexible sheet which is dimensionally thin in one direction, and which supports a number of fuel cells. The fuel cells may have active areas of one type (e.g., cathodes) that may be accessible from a first face of the sheet and active areas of another type (e.g., anodes) that are accessible from an opposing second face of the sheet. The active areas may be configured to lie within areas on respective faces of the sheet. For example, it is not necessary that the entire sheet be covered with active areas; however, the performance of a fuel cell may be increased by increasing its active area.

As used herein, “interface structure” or “interface layer” may refer to a fluidic interface configured to affect a local environment proximate to a fuel cell component, such as, for example, a fuel cell anode and/or a fuel cell cathode.

As used herein, “cover” may refer to an apparatus that encloses, or contacts, or is proximate to one or more fuel cells that includes an interface structure that is configured to affect an environmental condition proximate to the one or more fuel cells.

As used herein, “feature” may refer to an aspect of a fuel cell cover, which may be structured into the cover or may be an inherent property of a material used in the cover. Examples of features may include ports, holes, slots, mesh, porous materials, filters and labyrinth passages.

As used herein, “external environment” or “external conditions” or “environmental conditions” or “ambient environment” may refer to the atmospheric conditions in proximity to a cover or a interface structure, whether that environment resides inside or outside a device or housing. Accordingly, external conditions may include one or more of a temperature, a pressure, a humidity level, a pollutant level, a contaminant level, or other external conditions. “External environment” or “external conditions” or “environmental conditions” or “ambient environment” may also refer to more than one of a temperature, a pressure, a humidity level, a pollutant level, a contaminant level, or other external conditions in combination.

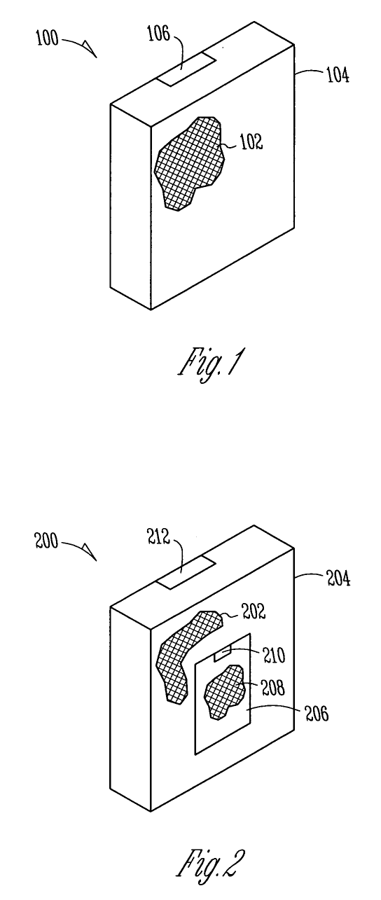

Referring to FIG. 1, a perspective view of a fuel cell cover 100 according to the various embodiments. The fuel cell cover 100 may include an interface structure 102, which may be structured into an enclosure 104, inherent in a material used to form the enclosure 104, or otherwise proximate to a fuel cell or a fuel cell layer. The fuel cell cover 100 may be partially or fully integrated with a surface of a fuel cell or a fuel cell layer. Suitable fuel cell structures, devices and systems may be found in the following commonly-owned U.S. Patent Applications: U.S. patent application Ser. No. 11/047,560, entitled “ELECTROCHEMICAL CELLS HAVING CURRENT-CARRYING STRUCTURES UNDERLYING ELECTROCHEMICAL REACTION LAYERS”; U.S. patent application Ser. No. 11/327,516, entitled “FLEXIBLE FUEL CELL STRUCTURES HAVING EXTERNAL SUPPORT” (attorney docket no. 2269.096us1); U.S. patent application Ser. No. 11/185,755, entitled DEVICES POWERED BY CONFORMABLE FUEL CELLS' (attorney docket no. 2269.090us1) and U.S. patent application Ser. No. (______) (attorney docket no. 2269.071us1), entitled “FUEL CELL SYSTEMS INCLUDING SPACE-SAVING FLUID PLENUM AND RELATED METHODS”, filed Sep. 25, 2008; all of which are herein incorporated by reference. For example, the cover 100 may include an interface layer that is positioned proximate to a fuel cell device. The interface structure 102 may extend across substantially an entire external surface of the enclosure 104, or it may extend across only a portion of the external surface of the enclosure 104. The interface structure 102 may be configured to enhance the performance of the one or more fuel cells (not shown) positioned within the enclosure 104 in a selected set of one or more environmental conditions. Accordingly, the interface structure 102 may include features such as ports, holes, slots, a mesh, a porous material, a filter network or any combination thereof. The interface structure 102 may also include an adaptive material, which will be described in greater detail below.

The interface structure 102 may be operable to exclude selected materials, such as atmospheric pollutants or excess water (e.g., humidity) in an external environment. The interface structure 102 may also be operable to admit selected materials, such as water, when the cover 100 is exposed to a dry external environment. The size, porosity and orientation of features in the interface structure 102 may be varied to affect the flow or to control a flow of a material to the fuel cell, depending on the desired conditions.

The interface structure 102 may be operable to affect one or more selected local environmental conditions. For example, the interface structure 102 may be incorporated into the enclosure 104 so that it is removable and may be changed to provide another interface structure 102 having different physical characteristics, which may depend on the environmental conditions present at the time of fuel cell operation. For example, one interface structure 102 may be configured for use in an environment which is hot and dry, such as a desert, while another interface structure 102 may be configured for use in an environment which is hot and wet, such as a rainforest. Still another interface structure 102 may be configured for use in an environment which is cool and wet; while another interface structure 102 may be configured for use in an environment which is cold and dry. The above examples illustrate possible variations for an interchangeable interface structure 102, depending on the ambient environment. Both the materials and the features that may be associated with the interface structure 102 may be selected and/or adapted to enable a fuel cell layer to operate over a wide range of environmental conditions. Although FIG. 1 shows the interface structure 102 disposed on a portion of the enclosure 104, it is understood that in the various embodiments, that the interface structure 102 and the enclosure 104 may be coincident structures, so that the entire enclosure 104 may constitute the interface structure 102, so that the foregoing interchangeability may extend to the entire fuel cell cover 100. It is also understood that in the various embodiments, the interface structure 102 may directly contact (or may be integrated into) the one or more fuel cells enclosed within the enclosure 104, or the interface structure 102 may be spaced apart from the one or more fuel cells enclosed within the enclosure 104. The one or more features in the interface structure 102 may respond to a change in to one or more environmental conditions near or in contact with the one or more fuel cells in order to enhance the performance of the fuel cells. The features may be incorporated into, or may be inherent to one or more adaptive materials.

The enclosure 104 may comprise materials such as paper, various polymers such as NYLON (manufactured by E. I. du Pont de Nemours and Company, Wilmington, Del.), and manufactured fibers in which the fiber forming substance is a long-chain synthetic polyamide in which less than 85% of the amide-linkages are attached directly (—CO—NH—) to two aliphatic groups), polytetrafluoroethylene (PTFE), polyvinylidene difluoride (PVDF), polyvinyl alcohol or polyethylene, for example. The enclosure 104 may comprise features that may be embodied in some combination of the above listed materials, one or more adaptive materials, or may be formed in the interface structure 102, for example.

The interface structure 102 may be comprised of adaptive materials that may physically or chemically respond to a change in one or more environmental conditions, which may include a temperature, a pressure (such as atmospheric pressure, the partial pressure of oxygen in air), a humidity, a pH level, various chemical compounds and/or light. Accordingly, the interface structure 102 may enhance the performance of the one or more fuel cells that may be positioned in the enclosure 104. Examples of suitable adaptive materials may include waxes, fibers or coatings, as disclosed, for example, in U.S. Pat. No. 4,708,812 to Hatfield, and entitled “ENCAPSULATION OF PHASE CHANGE MATERIALS”; U.S. Pat. No. 4,756,958 to Bryant, et al., entitled “FIBER WITH REVERSIBLE ENHANCED THERMAL STORAGE PROPERTIES AND FABRICS MADE THEREFROM”; and U.S. Pat. No. 6,514,362 to Zuckerman, et al., entitled “FABRIC WITH COATING CONTAINING ENERGY ABSORBING PHASE CHANGE MATERIAL AND METHOD OF MANUFACTURING SAME”; all of which are incorporated herein by reference. Other suitable adaptive materials may include various shape memory polymers (SMP), as disclosed, for example, in U.S. Pat. No. 6,627,673 to Topolkaraev, et al., and entitled “METHODS OF MAKING HUMIDITY ACTIVATED MATERIALS HAVING SHAPE MEMORY”, which is also incorporated herein by reference.

Shape memory polymers may be stimulated by a temperature, a pH level, various chemical compounds, and/or light. In general, shape memory polymers are polymer materials configured to sense and respond to external stimuli in a predetermined manner. Additional examples of suitable shape memory polymers are any of the polyurethane-based thermoplastic polymers (SMPUs). Such materials demonstrate a shape memory effect that is temperature-stimulated based on the glass transition temperature of the polymer (which may be between approximately −30 C and +65 C). Fibers made from SMPs may be used to make shape memory fabrics and textiles, such as an aqueous SMPU. Another example of a suitable SMP may include a polyethylene/NYLON-66 graft copolymer.

SMPs may be suitably configured so that physical properties, such as water vapor permeability, air permeability, volume expansivity, elastic modulus, and refractive index may vary above and below the glass transition temperature. SMPs used to control water vapor permeability may include elastomeric, segmented block copolymers, such as polyether amide elastomer or polyurethane elastomer.

Shape memory alloys (SMA) are a further example of materials which may be utilized in an interface structure 102, in accordance with the various embodiments. One or more SMA may be used, for example, to configure a pore size of the in the interface structure 102 in response to an environmental condition, such as temperature, humidity or other physical stimuli. Multiple SMAs with multiple transition temperatures may be used to provide environmental adaptability over a range of temperatures. For example, at least two SMAs with differing transition temperatures may cooperatively form actuators that provide environmental adaptability. Accordingly, as the temperature rises, the interface structure 102, including the SMA actuators is heated. When a transition temperature of the first SMA actuator is reached, the SMA actuator contracts to reduce air access to the cathodes. As the temperature increases still further, the transition temperature of the second SMA actuator may be reached, resulting in the second SMA actuator contracting and further reducing the air access to the cathodes. Alternatively, the SMA actuators may be configured to be controlled by a current applied across the SMA actuator, which may be applied, for example, in response to an applied signal.

Thermoresponsive polymers that exhibit positive swelling behavior with an increase in temperature may be used. One such material is described in the paper “Synthesis and Swelling Characteristics of pH and Thermoresponsive Interpenetrating Polymer Network Hydro gel Composed of Poly(vinyl alcohol) and Poly(acrylic acid), authored by Young Moo Lee, et al. (Journal of Applied Polymer Science 1996, Vol. 62, 301 311). In addition to the thermoresponsive materials exhibiting positive swelling, thermoresponsive polymers with negative swelling may also be used. When using materials with negative swelling behavior, a boundary condition of the material layer may be such as to allow the pores to shrink with an increase in temperature. A combination of materials exhibiting positive and negative swelling may also be used to realize variable porosity behavior of the GDL. Additional materials that exhibit variable porosity behavior are described in “Separation of Organic Substances with Thermoresponsive Polymer Hydrogel” by Hisao Ichijo, et al. (Polymer Gels and Networks 2, 1994, 315 322 Elsevier Science Limited), and “Novel Thin Film with Cylindrical Nanopores That Open and Close Depending on Temperature: First Successful Synthesis”, authored by Masaru Yoshida, et.al. (Macromolecules 1996, 29, 8987 8989).

In accordance with the various embodiments, a property of an adaptable material may be varied in response to an environmental condition in proximity to the electrochemical cells of the array. The property of the adaptable material may include its porosity, hydrophobicity, hydrophillicity, thermal conductivity, electrical conductivity, resistivity, overall material shape or structure, for example. The environmental conditions may include one or more of a temperature, humidity, or environmental contaminants level.

In accordance with the various embodiments, a property may also be varied in response to an applied signal, for example. The adaptive material may be heated in response to the signal. For example, by heating the adaptive material, one or more of the adaptive material properties may be varied. The performance of the electrochemical cell array may also be determined periodically or continuously monitored. Examples thermo-responsive adaptable materials are described in U.S. Pat. No. 6,699,611, filed May 29, 2001, entitled “FUEL CELL HAVING A THERMO-RESPONSIVE POLYMER INCORPORATED THEREIN,” and U.S. Pat. No. 7,132,192 to Muthuswamy, et. al, entitled “FUEL CELL USING VARIABLE POROSITY GAS DIFFUSION MATERIAL”, the disclosure of which is incorporated herein.

Other examples of adaptive materials may include woven materials having fibers or ribbons which may increase in length as humidity increases, therefore increasing the porosity of the weave and increasing air access to the cathodes of the fuel cells. Conversely, the fibres shorten when humidity decreases, thereby decreasing the porosity of the weave and decreasing air access to the cathodes, enabling the membrane to self-humidify.

In the various embodiments, the interface structure 102 may be adaptable using a mechanical means, such as a louvre or a port having a variable aperture. Such mechanical adaptations may be accomplished automatically in response to an applied signal, such as from a sensor, or by a manual input.

The fuel cell cover 100 may also optionally include an attachment mechanism 106 that is suitably configured to physically and/or electrically couple to an external electronic device. The attachment mechanism 106 may be a clip, a lock, a snap or other suitable attachment devices.

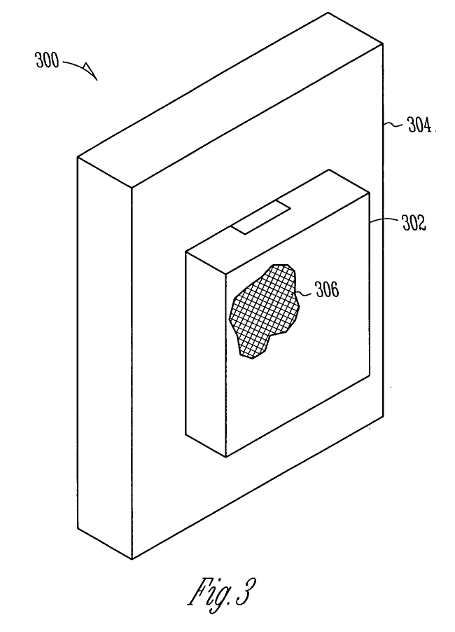

Referring to FIG. 2, a perspective view of a fuel cell cover 200 is shown, according to the various embodiments. The fuel cell cover 102 may include a first interface structure 202 that is formed on at least a portion of an external surface of an enclosure 204. The fuel cell cover 200 may also include a removable access plate 206 that permits access to an interior portion of the enclosure 204. The access plate 206 may include a second interface structure 208 having different properties (e.g., a different porosity, material or response characteristic to an environmental condition) than the first interface structure 202. Accordingly, in the various embodiments, the removable access plate 206 may be interchanged with other access plates 206 having different characteristics, so that the environmental conditions proximate to the fuel cells within the enclosure 204 may be “fine-tuned”. The access plate 206 may thus allow customization of the cover 200, since interchangeable materials, meshes, porous materials, screens, vents or filters may be utilized. Optional attachment mechanisms 210 and 212 may be included that may be configured to couple the access plate 206 to the enclosure 204, and to couple the enclosure 204 to an electronic device, respectively.

The cover 200, or portions thereof, may be may manufactured of an adaptive material, and the removable access plate 206 may be configured to take into account a set of selected environmental conditions, and may include features to enable optimized performance under such conditions. Such an arrangement allows the cover 200 to have adaptive and interchangeable capabilities. In addition, it is understood that the foregoing optimization may be accomplished where the cover 200 and/or the interface structure are interchangeable.

Alternatively, the cover 200, its features, materials, or components may be adaptable or may be optimized for a given set of environmental conditions. Depending on the environmental conditions, it may be configured to allow more or less oxidant to access the cathodes of the fuel cell layer. For example, under hot and/or dry conditions, an ion exchange membrane of a fuel cell may be subject to drying out. Under such environmental conditions, the cover 200 (and/or the first interface structure 202 and the second interface structure 208) may be configured to reduce air flow to the cathodes, to increase the ability of the ion exchange membrane to self-humidify. In contrast, under environmental conditions that include high levels of humidity, the ion exchange membrane may be prone to flooding, and therefore the cover 200 may be configured to increase air flow to the cathodes, for example by increasing the pore size of an adaptive material comprising the first interface structure 202 and the second interface structure 208, or utilizing a more porous first interface structure 202 and/or second interface structure 208. In the various embodiments, it is understood that the second interface structure 208 may be optional.

The fuel cell cover 200 (and/or the first interface structure 202 and the second interface structure 208) may affect both in-plane and through-plane conductivity and mobility of both reactants and products of the electrochemical reaction. For example, in the various embodiments, in-plane distribution of product water may be promoted across a fuel cell layer to provide even humidification of the ion-exchange membrane across the fuel cells, in addition to enabling balanced evaporation from a fuel cell system.

Further, in the various embodiments, the various attributes of the fuel cell cover 200 discussed above may be configured to be distributed in a non-uniform and/or asymmetric fashion across fuel cell layers. For example, and in accordance with the various embodiments, features (e.g., holes, perforations, or other openings) closer to the edge of the active area of a fuel cell may have a relatively higher or lower porosity compared to features closer to the center of the active area of a fuel cell. Properties of the features may be varied to increase or decrease air access to the cell depending on the position relatively to the cell geometry.

In the various embodiments, aspects of the cover 200 may be exchangeable or disposable. For example, the cover 200 may comprise a filter element, which may be disposable. A filter may be used in environments where there may be excess levels of pollutants or contamination to prevent such pollutants from reaching the cathodes of the fuel cell layer. The filter may be configured to be field-replaceable at the discretion of the user of the portable electronic device, or as necessary. In the various embodiments, the filter may be incorporated into or accessible via the removable access plate 206.

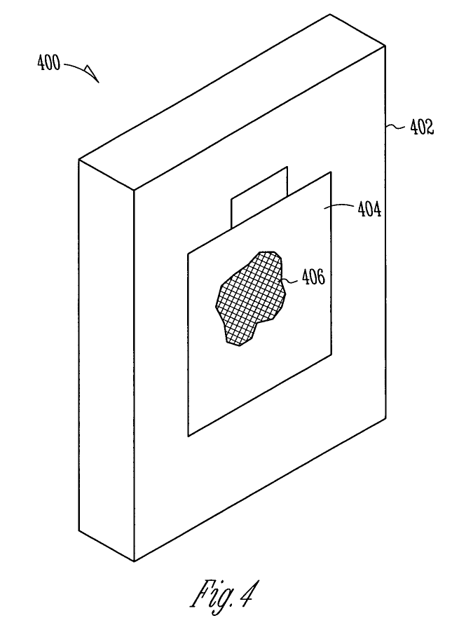

Referring to FIG. 3, a perspective view of an electronic system 300 according to the various embodiments. The electronic system 300 may include a fuel cell cover 302, which may include, for example, any of the embodiments disclosed in connection with FIG. 1 and FIG. 2. An electronic device 304 may be in contact with a fuel cell cover 302. The electronic device 304 may be configured to be removably engaged to the fuel cell cover 302. The fuel cell cover 302 may include one or more interface structures 306, as previously described. An optional attachment mechanism 308 may be configured to couple the fuel cell cover 302 to the electronic device 304.

The electronic device 304 may include a cellular phone, a satellite phone, a PDA, a laptop computer, an ultra mobile personal computer, a computer accessory, a display, a personal audio or video player, a medical device, a television, a transmitter, a receiver, a lighting device, a flashlight, a battery charger, a portable power source, or an electronic toy, for example. The cover 302 may contain all or part of a fuel cell or a fuel cell system, including a fuel enclosure, for example. The cover 302 alternatively may contain no components of the fuel cell system, as will be described in greater detail below.

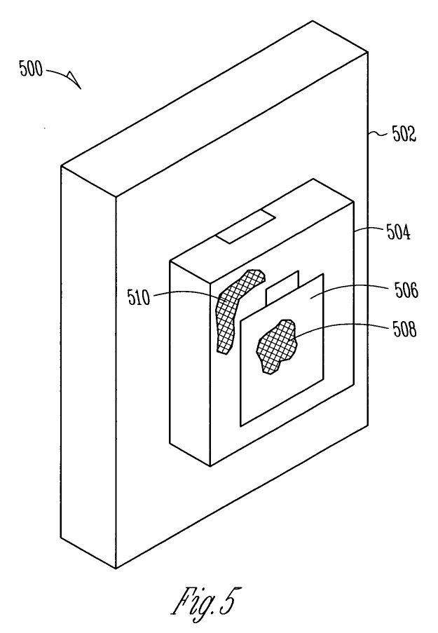

Referring now to FIG. 4, a perspective view of an electronic system 400 according to the various embodiments. The electronic system 400 may include an electronic device 402 that may further include fuel cell cover 404 that may optionally be substantially flush with a surface of the electronic device 402. The cover 404 may include one or more interface structures 406, as previously described, and an optional attachment mechanism 308 to couple the cover 404 to the electronic device 402. The cover 404 may be flush or substantially flush with the electronic device 402, so that little to no exterior profile of the cover 404 protrudes from a face of the electronic device 402.

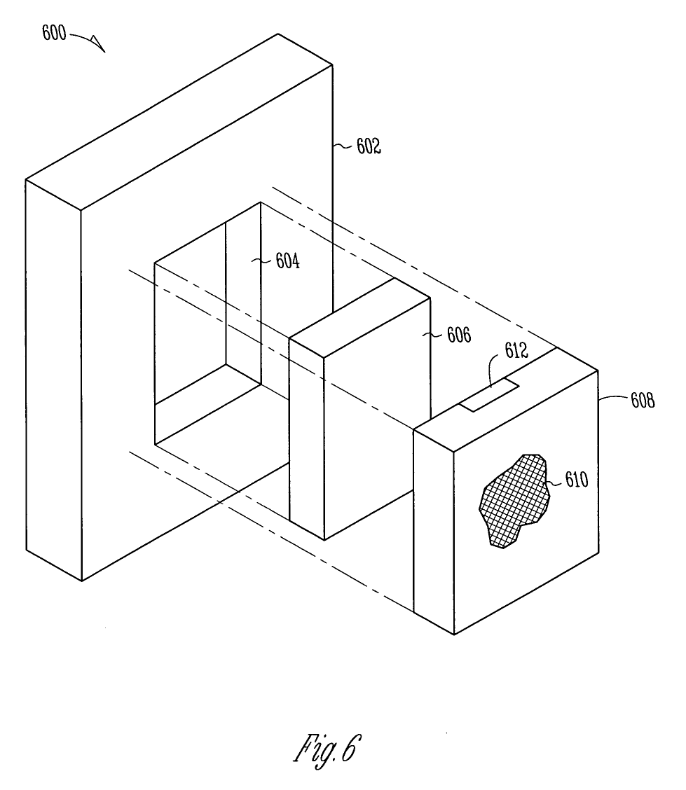

Referring to FIG. 5, a perspective view of an electronic system 500 is shown, according to the various embodiments. The electronic system 500 may include an electronic device 502 that may be operably coupled to a fuel cell cover 504. The cover 504 may include a removable access plate 506 that may further include one or more interface structures 508 and an optional attachment mechanism 510. The cover 504 may also include one or more interface structures 510. The cover 504 may be interchangeable, and the access plate 502 may also be interchangeable, therefore increasing the ability to adjust the environmental conditions near or in contact with a fuel cell enclosed within the cover 504.

Referring to FIG. 6, an exploded view of an electronic system 600 is shown, according to the various embodiments. The system 600 may include an electronic device 602 that may further include a recess 604 configured to receive one or more fuel cell layers 606, and, optionally, one or more fuel cartridges, fluidics, power conditioning, or combinations thereof, which may be operably coupled to the fuel cell layers. The fuel cell layers 606 may therefore be operably coupled to the electronic device 602. A fuel cell cover 608 may be positioned on the electronic device 602 or may be positioned on the fuel cell layers 606. The fuel cell cover 608 may include one or more interface structures 610, as previously described. Attachments 612 may also optionally couple the cover 608 to the electronic device 602. In such cases, the combination of the fuel cell layers, fuel cell cover, and optionally other aspects (e.g. fuel cartridge, fluid manifolding, valves, pressure regulators, etc) may form a fuel cell system, which may then be coupled as a fuel cell system to the electronic device.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A fuel cell cover comprising:
an interface structure proximate to one or more fuel cells, wherein the interface structure is configured to affect one or more environmental conditions proximate to the one or more fuel cells.

2. The fuel cell cover of claim 1, wherein the interface structure comprises at least one of an adaptive material and a removable porous structure configured to affect one or more environmental conditions proximate to the one or more fuel cells.

3. The fuel cell cover of claim 1, wherein the interface structure includes a filter element configured to exclude an atmospheric contaminant.

4. The fuel cell cover of claim 1, wherein the interface structure comprises at least one of a mechanically actuated vent and a porous material having mechanically actuated apertures.

5. The fuel cell cover of claim 1, wherein the interface structure comprises a shape memory adaptive material.

6. The fuel cell cover of claim 2, wherein the adaptive material is responsive to a change in one or more environmental conditions proximate to the one or more fuel cells.

7. The fuel cell cover of claim 5, wherein the shape memory adaptive material comprises at least one of a shape memory allot (SMA) and a shape memory polymer (SMP).

8. The fuel cell cover of claim 1, wherein the interface structure is configured to affect a humidity level, a temperature, a pollutant level and a contaminant level proximate to the one or more fuel cells.

9. The fuel cell cover of claim 1, further comprising an access plate positioned on the fuel cell cover that includes an additional interface structure.

10. The fuel cell cover of claim 9, wherein the additional interface structure on the access plate comprises one of an adaptive material and a removable porous structure.

11. The fuel cell cover of claim 9, wherein the access plate is removably engageable with the fuel cell cover.

12. The fuel cell cover of claim 1, wherein the interface structure is electrically conductive.

13. The fuel cell cover of claim 1, wherein the interface structure is electrically non-conductive.

14. A fuel cell cover, comprising:
an interface layer coupled to a fuel cell layer, wherein the interface layer is configured to enhance the performance of the fuel cell layer with respect to one or more selected environmental conditions.

15. The fuel cell cover of claim 14, wherein the interface layer comprises one of an adaptive material and a porous structure configured to enhance the performance of the fuel cell layer.

16. The fuel cell cover of claim 14, wherein the interface layer is electrically conductive.

17. The fuel cell cover of claim 14, wherein the interface layer is electrically non-conductive.

18. The fuel cell cover of claim 14, wherein the interface layer is removably coupled to the fuel cell layer.

19. An electronic system comprising:
an electronic device;
one or more fuel cells operably coupled to the electronic device; and
an interface structure proximate to the one or more fuel cells, wherein the interface structure affects one or more environmental conditions near or in contact with the one or more fuel cells.

20. The electronic system of claim 19, wherein the electronic device comprises one of a cellular phone, a satellite phone, a personal digital assistant (PDA), a laptop computer, an ultra mobile personal computer, a computer accessory, a display, a personal audio or video player, a medical device, a television, a transmitter, a receiver, a lighting device, a flashlight, a battery charger, a portable power source and an electronic toy.

21. The electronic system of claim 19, wherein at least a portion of the interface structure is electrically conductive.

22. The electronic system of claim 19, wherein the interface structure is electrically non-conductive.

23. The electronic system of claim 19, wherein the interface structure is removably coupled to the one or more fuel cells.

24. The electronic system of claim 23, wherein the interface structure includes an adaptive material.

25. The electronic system of claim 24, wherein the adaptive material includes a shape memory material.

26. The electronic system of claim 19, further comprising an electrically conductive gas diffusion layer in contact with an electrically non-conductive interface structure and the one or more fuel cells.

27. A method for optimizing the performance of a fuel cell system, comprising:
providing a fuel cell layer; and
positioning an interface layer proximate to the fuel cell layer, wherein the interface layer is responsive to at least one environmental condition proximate to the fuel cell layer.

28. The method of claim 27, wherein positioning an interface layer comprises contacting the fuel cell layer and the interface layer.

29. The method of claim 27, wherein positioning an interface layer comprises positioning an adaptive material proximate to the fuel cell layer.

30. The method of claim 27, wherein positioning an interface layer comprises positioning a removably coupleable interface layer adjacent to the fuel cell layer.

31. The method of claim 27, comprising selecting a property of the interface layer by manually replacing the interface layer.

32. The method of claim 27, comprising automatically selecting a property of the interface in response to a change in at least one environmental condition proximate to the fuel cell layer.
